(19) United States
(12) Patent Application Publication
(10) Pub. No.: US 2026/0203130 A1
(43) Pub. Date: Jul. 16, 2026

(54) APPLICATION PLACEMENT USING REPELLING POLICIES

(71) Applicant: Dell Products L.P., Round Rock, TX (US)

(72) Inventors: Ching-yun Chao, Austin, TX (US); John Madison Moran, Mebane, NC (US); Samuel Aaron Prince, Georgetown, TX (US)

(21) Appl. No.: 19/024,717

(22) Filed: Jan. 16, 2025

(51) Int. Cl. G06F 9/50

(52) U.S. Cl. CPC G06F 9/505; G06F 2209/5022

(57) ABSTRACT

A method for provisioning component applications (CPs) among a group of computing devices (CDs) includes receiving a request to add a first CP of the CPs to one CD of the group of CDs. The method further includes determining a group of CP costs, wherein each cost of the group of CP costs corresponds to adding the first CP to an associated CD of the group of CDs, wherein each cost of the group of CP costs is based on a first type of the first CP, a second type of CP currently running on the associated CD, and a number of CPs currently running on the associated CD. Additionally, the method includes placing the first CP on a first CD of the group of CDs associated with a lowest cost of the group of CP costs.

### BACKGROUND

Computing systems typically consist of networks of computing devices that host a variety of applications. These computing devices occasionally cease operating unexpectedly causing applications operating on the computing devices to become unavailable, leading to disruptions in application workloads. Strategically placing applications across computing systems can mitigate this risk and avoid single points of failure.

### BRIEF DESCRIPTION OF DRAWINGS

Certain embodiments of the disclosure will now be described with reference to the accompanying drawings. However, the accompanying drawings illustrate only certain aspects or implementations of the disclosure by way of example and are not meant to limit the scope of the claims.

FIG. 1 shows a diagram of a system in accordance with one or more embodiments.

FIG. 2 shows a flowchart of a method for provisioning component applications among a group of computing devices in accordance with one or more embodiments.

FIG. 3 shows a flowchart of a method for provisioning component applications among a group of computing devices in response to an update in accordance with one or more embodiments.

FIG. 4 shows a flowchart of a method for provisioning component applications among a group of computing devices in response to a computing device going offline in accordance with one or more embodiments.

FIG. 5 shows a diagram of a computing system in accordance with one or more embodiments.

### DETAILED DESCRIPTION

Distributed computing systems are comprised of interconnected computing devices each hosting various applications (e.g., resource allocation management, workload management, key management, storage management, etc.). While these systems are designed for efficiency and scalability, individual computing devices can fail for many reasons including hardware issues, software issues, network disruptions, etc. Such failures risk compromising the applications they host and, in turn, risk the availability of the application to end users. To avoid a single point of failure, the applications should be distributed across multiple computing devices strategically. Currently, computing systems use rule sets when placing different applications amongst the computing devices to avoid single points of failure. While traditional rules may work well when distributing applications for a fixed number of applications, the addition of one or more new applications or changes to the existing set of applications often requires manual intervention due to conflicts introduced by the new or changing applications.

In light of the limitations discussed above, the following disclosure includes a cost prediction engine that uses cost functions to optimize application distribution by determining the minimum total cost associated with optimal application placement amongst a group of computing devices.

Specific embodiments will now be described with reference to the accompanying figures.

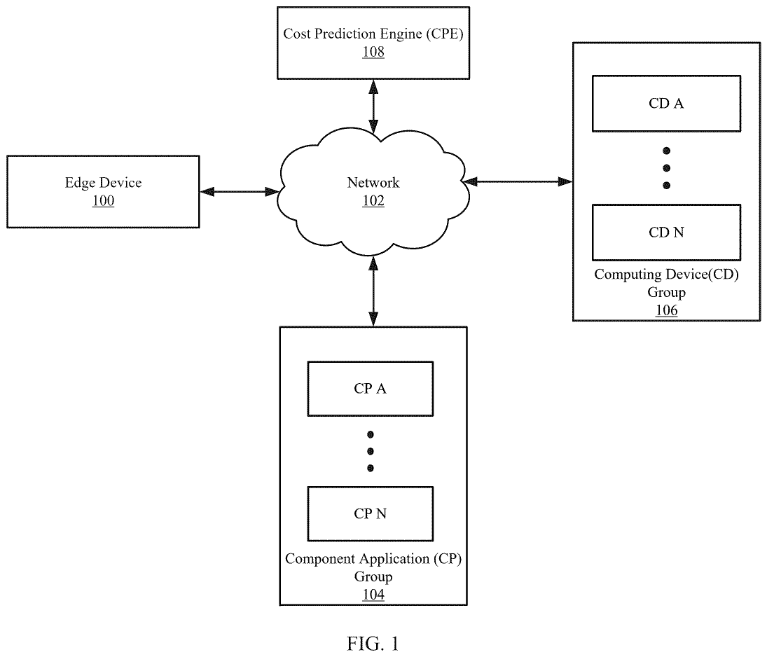

FIG. 1 shows a system in accordance with one or more embodiments. The system may include an edge device (100), a network (102), a component application (CP) group (104), a computing device (CD) group (106), and a cost prediction engine (CPE) (108). The system may include additional, fewer, and/or different components without departing from the scope of the embodiments disclosed herein. Each component may be operably/operatively connected to any of the other components via any combination of wired and/or wireless connections. Each of these system components is described below.

In one or more embodiments, the edge device (100), the CP group (104), the CD group (106), and the CPE (108) may be operatively connected to one another through the network (102) (e.g., a local area network (LAN), a wide area network (WAN) such as the Internet, a mobile network, any other network type, or a combination thereof). Further, the network (102) may encompass various interconnected, network-enabled subcomponents (or systems) (e.g., switches, routers, gateways, etc.) that may facilitate communications between the aforementioned components. Moreover, the edge device (100), the CP group (104), the CD group (106), and the CPE (108) may communicate with one another using any combination of wired and/or wireless communication protocols.

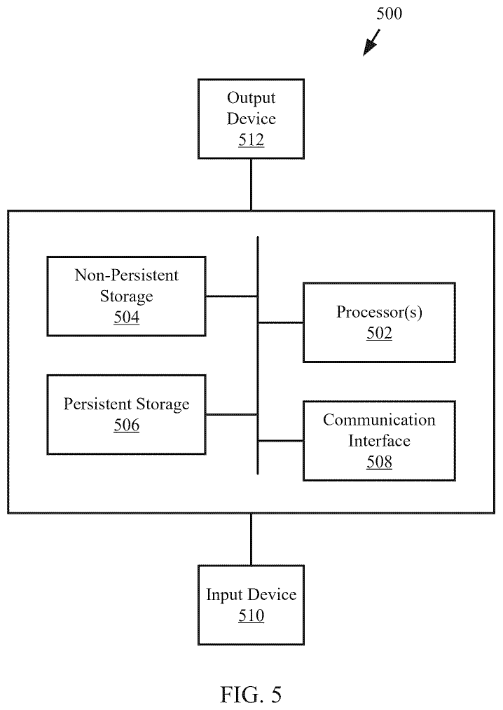

In one or more embodiments, the edge device (100) may be a physical device such as a personal computing system (e.g., a laptop, a cell phone, a tablet computer, a server, etc.) configured for hosting one or more workloads, or for providing a computing environment whereon workloads may be implemented. For example, the edge device (100) may be a computing system (e.g., 500, FIG. 5) as discussed below in more detail in FIG. 5. In one or more embodiments, the edge device (100) may include a user interface (e.g., a graphical user interface) (not shown) that allows a user to interact with the edge device (100). In one or more embodiments, the edge device (100) allows the user to interact with CPs hosted on the CD group (106).

In one or more embodiments, the edge device (100) may include any number of applications (and/or content accessible through the applications) that provide computer-implemented services to a user. Applications may be designed and configured to perform one or more functions instantiated by a user of the edge device (100). In order to provide application services, each application may host similar or different components. The components may be, for example (but not limited to), instances of databases, instances of email servers, etc. Applications may be executed on one or more edge device(s) (100) as instances of the application.

Applications may vary in different embodiments, but in certain embodiments, applications may be custom developed or commercial (e.g., off-the-shelf) applications that a user desires to execute on the edge device (100). In one or more embodiments, applications may be logical entities executed using computing resources of the edge device (100). For example, applications may be implemented as computer instructions stored on persistent storage of the edge device (100) that when executed by the processor(s) of the edge device (100), cause the edge device (100) to provide the functionality of the applications described throughout the application.

In one or more embodiments, while performing, for example, one or more operations requested by a user, applications installed on the edge device (100) may include functionality to request and use physical and logical resources of the edge device (100). Applications may also include functionality to use data stored in storage/memory resources of the edge device (100). The applications may perform other types of functionalities not listed above without departing from the scope of the embodiments disclosed herein. While providing application services to a user, applications may store data that may be relevant to the user in storage/memory resources of the edge device (100).

In one or more embodiments, to provide services to the users, the edge device (100) may utilize, rely on, or otherwise cooperate with an infrastructure node (IN) (not shown), each IN may include a portion or all of the CD group (108). For example, the edge devices (100) may issue requests to the IN to receive responses and interact with various components of the IN. The edge device (100) may also request data from and/or send data to the IN (for example, the edge devices (100) may transmit information to the IN that allows the IN to perform computations, the results of which are used by the edge device (100) to provide services to the users). As yet another example, the edge device (100) may utilize computer-implemented services provided by the IN. When the edge devices (100) interact with the IN, data that is relevant to the edge device (100) may be stored (temporarily or permanently) in the IN.

In one or more embodiments, the edge device (100) may be capable of, for example: (i) collecting users' inputs, (ii) correlating collected users' inputs to the computer-implemented services to be provided to the users, (iii) communicating with IN that perform computations necessary to provide the computer-implemented services, (iv) using the computations performed by the infrastructure nodes to provide the computer-implemented services in a manner that appears (to the users) to be performed locally to the users, and/or (v) communicating with any virtual desktop (VD) in a virtual desktop infrastructure (VDI) environment (or a virtualized architecture) provided by the IN (using any known protocol in the art), for example, to exchange remote desktop traffic or any other regular protocol traffic (so that, once authenticated, users may remotely access independent VDs).

As described above, the edge devices (100) may provide computer-implemented services to users (and/or other computing devices). The edge devices (100) may provide any number and any type of computer-implemented services. To provide computer-implemented services, an edge device (100) may include a collection of physical components (e.g., processing resources, storage/memory resources, networking resources, etc.) configured to perform operations of the edge device (100) and/or otherwise execute a collection of logical components (e.g., virtualization resources) of the edge device (100).

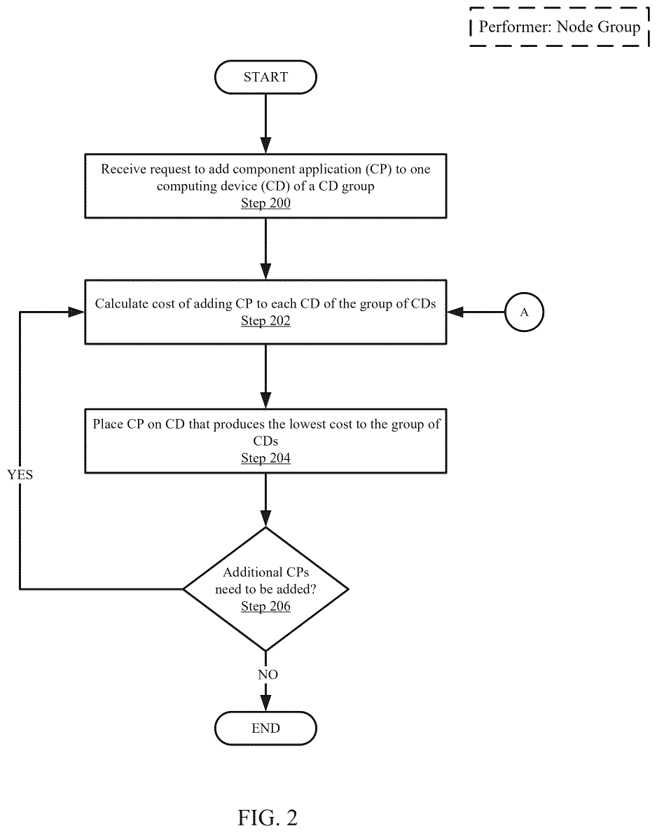

Further, the edge device (100) may include functionality to perform at least a portion of the methods shown in FIGS. 2-4. One of ordinary skill in the art will appreciate that the edge device (100) may perform other functionalities without departing from the scope of the embodiment disclosed herein.

In one or more embodiments, the CP group (104) includes CPs A-N, with each CP including the functionality to perform actions for CP group (104). In one or more embodiments, the CP group (104) refers to a collection of interconnected CPs that collectively perform tasks or functions within a computing environment. In one or more embodiments, CPs may include but should not be limited to applications, virtual machines, processes, containers, micro services, threads, etc. In one or more embodiments, a CP refers to an individual application designed to perform specialized tasks or functions. In one or more embodiments, the tasks and functions of the CP may include processing and analyzing data, managing specific resources such as memory or storage of the CD group (106) and executing algorithms to perform computing tasks (e.g., processing data, managing databases, running machine learning models, rendering graphics, facilitating communication between other devices, etc.). In one or more embodiments, each CP is specific to a task including but not limited to resource allocation management CPs, workload management CPs, key management CPs, storage management CPs, etc. In one or more embodiments, the CPs of the CP group (104) may each be hosted on a CD of the CD group (106). In one or more embodiments, more than one CP of the CP group (104) may be hosted on each CD of the CD group (106). In one or more embodiments, each CP running on the CDs of the CD group (106) consumes resources of the CDs. In one or more embodiments, the resource consumption of each CP on the CDs may be quantified as a computing cost, as discussed below in FIG. 2. Further, the CP group (104) may include functionality to perform at least a portion of the methods shown in FIGS. 2-4. One of ordinary skill in the art will appreciate that the CP group (104) may perform other functionalities without departing from the scope of the embodiment disclosed herein.

In one or more embodiments, the CD group (106) includes CD A-N, with each CD including the functionality to perform actions for the CD group (106). In one or more embodiments, the actions include hosting applications (e.g., the CPs of the CP group (104)), and executing computing tasks. In one or more embodiments, the CDs of the CD group (106) may be configured to send and receive information via the network (102) enabling communication with other devices or CDs. In one or more embodiments, each CP hosted on the CDs of the CD group (106) consumes resources from the CDs. Additionally, in one or more embodiments, each CD of the CD group (106) has a maximum resource capacity available for hosting the CPs. In one or more embodiments, the resource consumption of each application on the CDs may be quantified as a CD cost, as described below FIG. 2. In one or more embodiments, the resources may include computing resources (e.g., e.g., processors, graphic processing units (GPUs), application-specific integrated circuits (ASIC), etc.), storage resources (e.g., solid state drives (SSDs), random access memory (RAM), cloud storage, etc.), and communication resources. In one or more embodiments, there is more than one CD group (106). In one or more embodiments, one or more CDs of the CD group (106) may be a virtual CD. Further, the CD group (106) may include functionality to perform at least a portion of the methods shown in FIGS. 2-4. One of ordinary skill in the art will appreciate that the CD group (106) may perform other functionalities without departing from the scope of the embodiment disclosed herein.

In one or more embodiments, the CPE (108) includes the functionality to determine a CD group cost (i.e., the total cost of all the CPs running on each CD of the CD group (106)). In one or more embodiments, the CPE (108) includes the functionality to determine a minimum CD group cost associated with adding at least one additional CP to the CD group (106). In one or more embodiments, the CPE (108) may use cost functions to determine the CD group cost and the minimum CD group cost. In one or more embodiments, the cost functions are configured to encourage spreading CPs among the CDs of the CD group (106) and discourage placing the CPs on the same CD. It should be appreciated, that CDs may fail for a variety of reasons, thus allocating a large amount of CPs to the same CD creates a single point of failure. In one or more embodiments, the cost functions seek to discourage a single point of failure by assigning high costs to crowded CDs and low costs to uncrowded CDs. In one or more embodiments, any type of cost function may be used that is currently known in the art discovered in the future. Further, the CPE (108) may include functionality to perform at least a portion of the methods shown in FIGS. 2-4. One of ordinary skill in the art will appreciate that the CPE (108) may perform other functionalities without departing from the scope of the embodiment disclosed herein.

Turning to FIG. 2, FIG. 2 shows a flowchart of a method for provisioning component applications among a group of computing devices in accordance with one or more embodiments disclosed herein. The method may be performed by, for example, a CPE (e.g., 108 in FIG. 1). Other components in the system may perform this method without departing from the scope of the disclosure.

While the various steps in the flowchart shown in FIG. 2 are presented and described sequentially, one of ordinary skill in the relevant art, having the benefit of this Detailed Description, will appreciate that some or all of the steps may be executed in different orders, that some or all of the steps may be combined or omitted, and/or that some or all of the steps may be executed in parallel.

In step 200, the CPE (e.g., 108 in FIG. 1) receives a request to add a CP of a CP group (e.g., 104 in FIG. 1) to a CD of a CD group (e.g., 106 in FIG. 1). In one or more embodiments, the request is sent be an edge device (e.g., 100 in FIG. 1). In one or more embodiments, the request may specify the specific CP that is to be added. In one or more embodiments, the request may specify the resources (e.g., computing resources, storage resources, etc.) needed to host the CP.

In step 202, the CPE (e.g., 108 in FIG. 1) determines the cost of adding the CP to each CD of the CD group (e.g., 106 in FIG. 1). In one or more embodiments, the CPE (e.g., 108 in FIG. 1) may use a node cost function to determine the cost of adding the CP to each CD of the CD group (e.g., 106 in FIG. 1). In one or more embodiments, the cost function is configured to encourage spreading CPs among the CDs of the CD group (106 in FIG. 1) and discourage placing the CPs on the same CD. It should be appreciated, that CDs may fail for a variety of reasons, thus allocating a large amount of CPs to the same CD creates a single point of failure. The cost functions described below seek to discourage a single point of failure by assigning high costs to crowded CDs and low costs to uncrowded CDs. In one or more embodiments, CP types may include but should not be limited to resource allocation management CPs, workload management CPs, key management CPs, storage management CPs, etc. The following provides examples of cost functions, but it should be appreciated, that the cost functions are non-limiting examples and that any cost functions may be used that offer a similar result. Further, in one or more embodiments, the CPE (e.g., 108 in FIG. 1) may determine the node costs using any means known in the art or discovered in the future.

In one or more embodiments, the CPE (e.g., 108 in FIG. 1) may determine the cost using step and stair functions. In a non-limiting example, the step and stair function may be as follows:

$$stair ( x ) = \{ \begin{matrix}0 , x < 1 \\ 1 , 1 \leq x < 2 \\ … \\ n , n \leq x < n + 1\end{matrix}$$

$$step ( x ) = \{ \begin{matrix}0 , x \leq 0 \\ 1 , x > 0\end{matrix}$$

In one or more embodiments, the cost function may be configured to discourage placing more than one CP of the same type on the same CD. In one or more embodiments, the cost may increase rapidly (e.g., exponentially) when placing more than one CP of the same type on the same CD. It should be appreciated, that any function may be used to achieve this result that is known in the art or discovered in the future. A non-limiting example of such cost function may be as follows where i is the number of the same type of CPs on a CD:

$$cost ( i ) = step ( i ) \times α stair ( i ) = 0 , α , {α}^{2} , {α}^{3} , …$$

In one or more embodiments, the cost function may also be configured with a preference of putting different types of CPs on the same CD, over putting CPs of the same type on the same CD. In one or more embodiments, the cost function may be configured to make the cost grow faster when the same type of CP is on a CD than when different types of CPs are on a CD. It should be appreciated, that any function may be used to achieve this result that is known in the art or discovered in the future. A non-limiting example of such cost function may be as follows where i and j represent different types of CPs on the same CD:

$$CD cost = step ( i ) \times {α}^{stair ( i )} + step ( j ) \times {α}^{stair ( j )}$$

In one or more embodiments, the value of α (i.e., the base cost of a CP) for each type of CP is the same. As discussed above the cost of having two CPs of the same type on a CD should be higher cost than having two CPs of a different type on a CD. For this to hold true, it should be appreciated, that the value of α is larger than two (e.g., using Euler Number (i.e., 2.718281828459) as the value of α). The following example illustrates this concept:

$$\begin{matrix}if α \leq 2 then & x \times α \geq {α}^{x} \\ if α > 2 then & x \times α < {α}^{x}\end{matrix}$$

It should be appreciated, that in the cost function above, the step functions are added together rather than multiplied because, while it is better for the CPs to be spread out amongst the CDs, the risk of placing different types of CPs on the same CD is acceptable if there are not enough CDs. Further, if there are zero types of a particular CP on a CD then the cost would zero out resulting in inaccurate data. The following non-limiting example where there are two CP i and zero CP j on the same node (i.e., i=2 and j=0) illustrates this concept:

$$CD cost = step ( 2 ) \times {α}^{stair ( 2 )} + step ( 0 ) \times {α}^{stair ( 0 )} = {α}^{2} \times 0 = 0$$

In one or more embodiments, there may be a lot of CP types in the CP group (e.g., 104 in FIG. 1). A non-limiting example of a cost function that accommodates M CP types may be as follows:

$$CD cost = {\sum }_{m = 1}^{M} {CP}_{m} = {\sum }_{m = 1}^{M} step ( {i}_{m} ) \times {α}^{stair ( {i}_{m )}}$$

In one or more embodiments, the CPE (e.g., 108 in FIG. 1) may be configured to determine the CD group cost (i.e., the total cost of all the CPs running on each CD of the CD group (e.g., 106 in FIG. 1)). In one or more embodiments, the CPE (e.g., 108 in FIG. 1) uses the CD group to determine which CD to place the CP on. In one or more embodiments, the cost function of the CPE (e.g., 108 in FIG. 1) may be also configured to place a CP of a new type on a CD with the fewest CDs. In one or more embodiments, to achieve this result, the cost function may assign a higher cost to placing CPs on CDs with fewer CPs. In one or more embodiments, the cost function may achieve this result by squaring the total cost of each CD so that adding a new CP type to a node with fewer CPs results in a CD group cost. It should be appreciated, that this will help avoid a single point of failure. It should be appreciated, that any function may be used to achieve this result that is known in the art or discovered in the future. It should be appreciated, that the cost to place a CP on a CD with the least CPs may not always be lower if, for example, the CPs on the CD with the fewest CPs are the same type of CP that is being placed. Thus, the cost functions above may be combined to address this issue. A non-limiting example of such a function is as follows:

$$CD group cost = {\sum }_{n = 1}^{N} {( CD cost )}^{2} = {\sum }_{n = 1}^{N} {( {\sum }_{m = 1}^{M} step ( {i}_{m} ) \times {α}^{stair ( {i}_{m} )} )}^{2}$$

A non-limiting example applying the following function to five nodes is as follows:
a. Consider four CP types, X, Y, Z, and W where a vector is used to illustrate how many of each CP type are on a CD (e.g., [x y z w]=[1 0 0 0]), where each vector represents a node and α (i.e., CP base cost) is equal to Euler's number (i.e., e=2.718282).
b. Now assume that there are five CDs in the CD group (e.g., 106 in FIG. 1) represented by the following vectors:

```
[[0 0 0 0] ← CD 1
  [1 0 0 0] ← CD 2
  [1 1 0 0] ← CD 3
  [2 0 1 0] ← CD 4
  [3 0 0 1]] ← CD 5
```

c. The list below shows the result of the group cost function for each CD:
d. CD1 cost 4 CP types: [0 0 0 0]:
   cost of putting 0 CP X with a base cost e=2.718282 on CD1=0.000000
   cost of putting 0 CP Y with base cost e=2.718282 on CD1=0.000000
   cost of putting 0 CP Z with base cost e=2.718282 on CD1=0.000000
   cost of putting 0 CP W with a base cost e=2.718282 on CD1=0.000000
   cost of 4 CP types [0 0 0 0] on CD1=0.000000
   squared cost of 4 CP types [0 0 0 0] on CD1=0.000000
e. CD2 Cost 4 CP types: [1 0 0 0]:
   cost of putting 1 CP X with base cost e=2.718282 on CD2=2.718282
   cost of putting 0 CP Y with a base cost e=2.718282 on CD2=0.000000
   cost of putting 0 CP Z with a base cost e=2.718282 on CD2=0.000000
   cost of putting 0 CP W with a base cost e=2.718282 on CD2=0.000000
   cost of 4 CP types [1 0 0 0] on CD2=2.718282
   squared cost of these 4 CP types [1 0 0 0] on the CD2=7.389056
f. CD3 Cost 4 CP types: [1 1 0 0]:
   cost of putting 1 CP X with a base cost e=2.718282 on CD3=2.718282
   cost of putting 1 CP Y with base cost e=2.718282 on CD3=2.718282
   cost of putting 0 CP Z with a base cost e=2.718282 on CD3=0.000000
   cost of putting 0 CP W with a base cost e=2.718282 on CD3=0.000000
   cost of 4 CP types [1 1 0 0] on CD3=5.436564
   squared cost of these 4 CP types [1 1 0 0] on CD3=29.556224
g. CD4 Cost 4 CP types: [2 0 1 0]:
   cost of putting 2 CP X with base cost e=2.718282 on CP4=7.389056
   cost of putting 0 CP Y with a base cost e=2.718282 on CP4=0.000000
   cost of putting 1 CP Z with base cost e=2.718282 on CP4=2.718282
   cost of putting 0 CP W with a base cost e=2.718282 on CP4=0.000000
   cost of 4 CP types [2 0 1 0] on CD4=10.107338
   square cost of these 4 CP types [2 0 1 0] on CP4=102.158280
h. CD5 Cost 4 CP types: [3 0 0 1];
   cost of putting 3 CP X with a base cost e=2.718282 on CD5=20.085537
   cost of putting 0 CP Y with a base cost e=2.718282 on CD5=0.000000
   cost of putting 0 CP Z with a base cost e=2.718282 on CD5=0.000000
   cost of putting 1 CP W with a base cost e=2.718282 on CD5=2.718282
   cost of 4 CP types [3 0 0 1] on CD5=22.803819
   square cost of these 4 CP types [3 0 0 1] on CD5=520.014150
i. CD Group Cost=CD1²+CD2²+CD3²+CD4²+CD5²=659.11771

In one or more embodiments, the cost function of the CPE (e.g., 108 in FIG. 1) may also include a function configured to minimize the CD group cost when deciding where to place one or more additional CPs amongst the CD group (e.g., 106 in FIG. 1). In one or more embodiments, the CPE (e.g., 108 in FIG. 1) may determine the CD group cost for each CP placement configuration amongst the CDs of the CD group (e.g., 106 in FIG. 1) and choose the configuration with the smallest CD group cost. In one or more embodiments, once the smallest CD group cost is determined a user is notified via a graphical use interface (GUI) on an edge device (e.g., 100 in FIG. 1). A non-limiting example of a cost function that minimizes the CD group cost may be as follows:

$$min ( CD group cost ) = min ( {\sum }_{n = 1}^{N} {( {\sum }_{m = 1}^{M} step ( {i}_{m} ) \times {α}^{{〚 stair ( i 〛}_{m} )} )}^{2} )$$

Continuing with the non-limiting example above with CD1-CD5.

```
[[0 0 0 0] ← CD 1
  [1 0 0 0] ← CD 2
  [1 1 0 0] ← CD 3
  [2 0 1 0] ← CD 4
  [3 0 0 1]] ← CD 5
```

If an additional CP Y were to be added to the CD group (e.g., 106 in FIG. 1) above the min CD group cost function would find that placing CP Y on the CD1 would produce the minimum CD group cost. It should be appreciated, that this result should be expanded as CD1 had zero CPs on it prior to CP Y being added to it. It should be appreciated, that the CD cost function

$${\sum }_{m = 1}^{M} step ( {i}_{m} ) \times {α}^{{〚 stair ( i 〛}_{m} )}$$

recognizes the cost contributed from each CP type linearly (e.g., when placing a CP Y on CD1, the cost is independent of the number of CP X's on CD1). In one or more embodiments, placing a CP type by itself may be more advantageous to reduce computing resource contention from other CP types. For example, CP X may perform best when it is alone on a CD, or CP Y may not perform well if it is on the same CD as CP Z. In one or more, embodiments this can be accomplished by configuring the base CP cost of CP types to be dependent on the other CP types that are on the same CD. In a non-limiting example, the following base costs may be used for CP X, CP Y, CP, CP Z, and CP W:

| | CP X | CP Y | CP Z | CP W |
|---|---|---|---|---|
| Base CP cost | α | β | γ | δ |
| Case 1 | α = e | β = e | γ = e | δ = e |
| Case 2 | α = e + σ | β = e | γ = e − σ | δ = e − σ |

It should be appreciated, that in the non-limiting example above σ in Case 2 is a positive number. It should be further appreciated, that in Case 2 that e-σ to is greater than 2, so 0<σ<e−2. In one or more embodiments, any combination of rules may be implemented as long as they don't result in anomalies within the cost functions. For example, using the CD cost function above for reference, if any of the base costs are two or less, the cost functions will produce unhelpful results, as discussed above.

In one or more embodiments, the CDs of the CD group (e.g., 106 in FIG. 1) have a maximum capacity of CPs that they can support. It should be appreciated, that the minimum CD group cost function, as discussed above, will result in balanced CPs placement across CDs of the CD group (e.g., 106 in FIG. 1). It should be further appreciated, that balanced CP placement will ensure the maximum capacity of the CDs of the CD group (e.g., 106 in FIG. 1) is reached at the slowest rate. In one or more embodiments, any functions known in the art or discovered in the future may be used to achieve this result. It should be appreciated, that balancing the distribution of CPs across the CDs of the CD group (e.g., 106 in FIG. 1) is sufficient to prevent CDs from reaching their maximum capacity as long as all of the CDs in the CD group (e.g., 106 in FIG. 1) have the same capacity. In one or more embodiments, the CDs of the CD group (e.g., 106 in FIG. 1) may have different capacities (i.e., the amount of resources available to host CPs). In one or more embodiments, some CDs of the CD group (e.g., 106 in FIG. 1) have more available resources in terms of computing, memory, storage, networking, etc. In one or more embodiments, the CPE (e.g., 108 in FIG. 1) also takes the capacity of the resources of CDs into account when calculating the CD cost. In one or more embodiments, the cost function of the CPE (e.g., 108 in FIG. 1) is configured to assign a lower cost to placing CPs on higher-capacity CDs. It should be appreciated, that placing a lot of CPs on a higher-capacity CD may result in a single point of failure in the event the high-capacity CD goes offline. In one or more embodiments, the cost function is configured to assign a lower cost to placing CPs on high-capacity CDs provided that the placement does not result in placing a lot of CPs on the high-capacity CD while leaving low-capacity CDs of the CD group (e.g., 106 in FIG. 1) idle. It should be appreciated, that any function known in the art or discovered in the future may be used to achieve this result. A non-limiting example of a cost function that prioritizes high-capacity CDs, while avoiding leaving lower-capacity CDs idle may be as follows where cₙ represents the capacity of a CD:

$$CD cost = \frac{{\sum }_{m = 1}^{M} step ( {i}_{m} ) \times {α}^{{〚 stair ( i 〛}_{m} )}}{{c}_{n}} where {c}_{n} > 1$$

It should be appreciated, that the function above divides the standard CD cost function

$$( i . e . , cost = CD cost = {\sum }_{m = 1}^{M} {CP}_{m} = {\sum }_{m = 1}^{M} step ( {i}_{m} ) \times {α}^{stair ( {i}_{m )}}$$

by the CD size (i.e., cₙ) to represent a lower cost associated with higher capacity CDs. In one or more embodiments, this may be implemented into the minimum CD group cost function above.

In one or more embodiments, the CPE (e.g., 108 in FIG. 1) is configured to prevent CPs from being placed on CDs that don't have resources available to support any more CPs. In one or more embodiments, to accomplish this the CPE (e.g., 108 in FIG. 1) may assign an infinitely high cost to placing CPs on CDs that don't have resources available. In one or more embodiments, any functions known in the art or discovered in the future may be used to achieve this result. A non-limiting example of a cost function that accomplished this may be as follows:

$$CD cost ( x ) = \frac{step ( x ) \times {α}^{stair ( x )} + step ( y ) \times {α}^{stair ( y )}}{step ( CD remaing capacity - CP \times required resource )}$$

It should be appreciated, that in the function above, when the remaining capacity is larger than the required resources to run CP X, CD cost(x)=1, otherwise CD cost(x)=∞. In other words, if there is insufficient capacity to run CP X, the CD cost will be exceedingly high.

In one or more embodiments, the solutions above can be applied to calculating the optimal cost for re-balancing the distribution of CPs amongst the CDs of the CD group (e.g., 106 in FIG. 1) when additional CDs or CPs are added or subtracted from the CD group (e.g., 106 in FIG. 1). It should be appreciated, that the methods and functions in the solutions above may be applied to placing CPs, containers, processes, etc. on physical CDs or virtual CDs.

In step 204, the CP is placed on the CD of the CD group (e.g., 106 in FIG. 1) that produces the lowest cost to the CD group (e.g., 106 in FIG. 1) (i.e., the minimum CD group cost). In one or more embodiments, the lowest cost may refer to the CP that puts the least strain on the CD group (e.g., 106 in FIG. 1). In one or more embodiments, the CP may be placed on the CD by any means known in the art or discovered in the future.

In step 206, the CD group (e.g., 106 in FIG. 1) determines whether additional CPs need to be added to the CD group (e.g., 106 in FIG. 1). In one or more embodiments, the CD group (e.g., 106 in FIG. 1) may make this determination by any means known in the art or discovered in the future. Accordingly, if the result is YES then the method proceeds to step 202. If the result is NO, then the method ends. In one or more embodiments, steps 202-206 may repeat until the result is NO.

In one or more embodiments, the method may end following step 206.

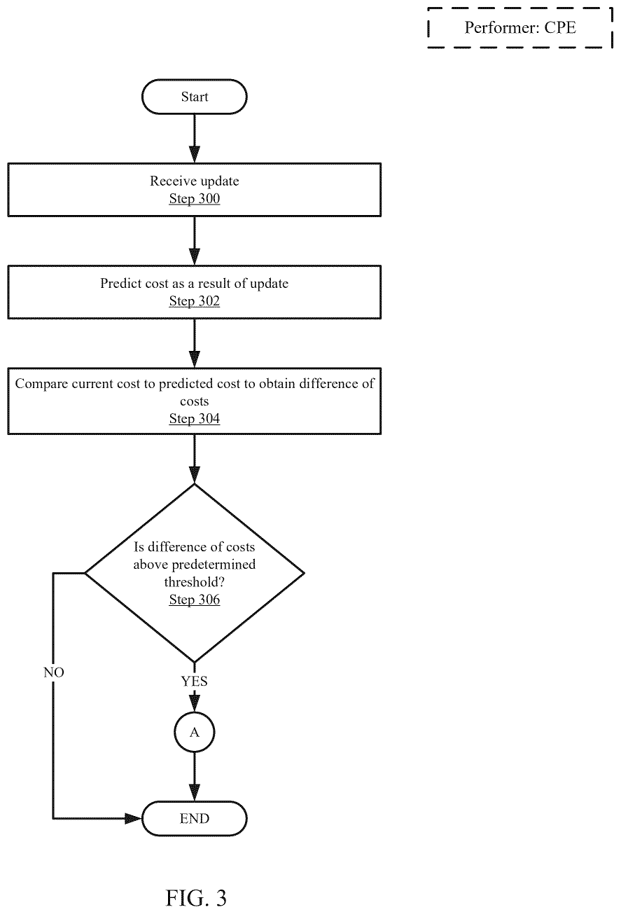

Turning to FIG. 3, FIG. 3 shows a flowchart of a method for provisioning component applications among a group of computing devices in response to an update in accordance with one or more embodiments disclosed herein. The method may be performed by, for example, a CPE (e.g., 108 in FIG. 1). Other components in the system may perform this method without departing from the scope of the disclosure.

While the various steps in the flowchart shown in FIG. 3 are presented and described sequentially, one of ordinary skill in the relevant art, having the benefit of this Detailed Description, will appreciate that some or all of the steps may be executed in different orders, that some or all of the steps may be combined or omitted, and/or that some or all of the steps may be executed in parallel.

In step 300, at least one CD of a CD group (e.g., 106 in FIG. 1) receives an update. In one or more embodiments, the update results in a change in the available resources of the at least one CD. Consequently, in one or more embodiments, the change in the available resources results in a change of a CD group cost (i.e., the total cost of all the CPs running on each CD of the CD group (e.g., 106 in FIG. 1)). In one or more embodiments, at least one CP of CP group (e.g., 104 in FIG. 1) also receives an update. In one or more embodiments, the update to the at least one CP results in a change in resource consumption of the at least one CP (i.e., at least one CP consumes more or fewer resources). Consequently, in one or more embodiments, the resource consumption results in a change of cost to the CD group cost.

In step 302, the CPE (e.g., 108 in FIG. 1) predicts the CD group cost as a result of the update. It should be appreciated, that the CD group cost may be precited using the methods described in FIG. 2. In one or more embodiments, the CPE (e.g., 108 in FIG. 1) predicts the CD group cost by any means known in the art or discovered in the future. In one or more embodiments, the predicted cost is represented by a numerical value (e.g., the predicted CD group cost is 758.453)

In step 304, the CPE (e.g., 108 in FIG. 1) compares the predicted CD group cost to the current CD group cost to obtain a difference of costs. In one or more embodiments, the current CD group cost is the CD group cost prior to the update. In one or more embodiments, the current CD group cost is represented by a numerical value (e.g., the current CD group cost is 597.236). In one or more embodiments, the CPE (e.g., 108 in FIG. 1) may compare the current cost and the predicted cost to obtain the difference of costs by any means known in the art or discovered in the future. In one or more embodiments, the difference of costs may be represented as a difference in vales (i.e., the predicted cost is 161.271 higher than the current cost) or by a percentage (e.g., the predicted cost is 21.26 percent higher than the current cost).

In step 306, the CPE (e.g., 108 in FIG. 1) determines whether the difference of cost is above a predetermined threshold. In one or more embodiments, the predetermined threshold may be dependent on the size of the difference of costs. Further, in one or more embodiments, the CD group (e.g., 106 in FIG. 1) may only be able to handle changes in cost up to a certain value or percentage (e.g., the CD group (e.g., 106 in FIG. 1) drops in efficiency when: the predicted cost is 100 points or higher than the current cost, the predicted cost is 35 percent or higher than the current cost, etc.). In one or more embodiments, the predetermined threshold may be dependent on the resource capacity of the CD group (e.g., 106 in FIG. 1) (e.g., the CD group (e.g., 106 in FIG. 1) efficiency drops when the CD group cost is above 750). In one or more embodiments, the predetermined threshold may be determined by any means known in the art or discovered in the future. Accordingly, if the result is YES then the method proceeds to step 202 in FIG. 1. If the result is NO then the method ends.

In one or more embodiments, the method may end following step 306.

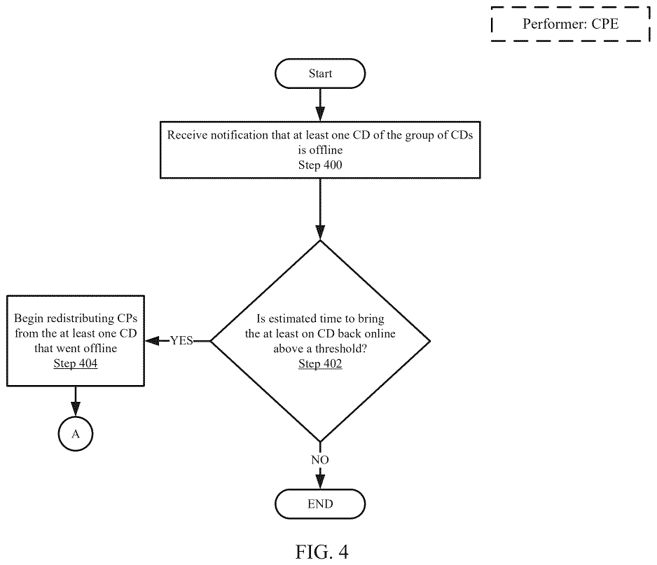

Turning to FIG. 4, FIG. 4 shows a flowchart of a method for provisioning component applications among a group of computing devices in response to a computing device going offline in accordance with one or more embodiments disclosed herein. The method may be performed by, for example, a CPE (e.g., 108 in FIG. 1). Other components in the system may perform this method without departing from the scope of the disclosure.

While the various steps in the flowchart shown in FIG. 4 are presented and described sequentially, one of ordinary skill in the relevant art, having the benefit of this Detailed Description, will appreciate that some or all of the steps may be executed in different orders, that some or all of the steps may be combined or omitted, and/or that some or all of the steps may be executed in parallel.

In step 400, the CPE (e.g., 108 in FIG. 1) receives a notification from a CD group (e.g., 106, in FIG. 1) that at least one CD of the CD group (e.g., 106 in FIG. 1) is offline. In one or more embodiments, the CD group (e.g., 106 in FIG. 1) also informs the CPE (e.g., 108 in FIG. 1) of the estimated time that it will take to bring the at least one CD back online. In one or more embodiments, the CD group (e.g., 106 in FIG. 1) may estimate the amount of time needed to bring the at least one CD online by any means known in the art or discovered in the future. In one or more embodiments, a user may be notified that the at least one CD has gone offline via a graphical user interface (GUI).

In step 402, CPE (e.g., 108 in FIG. 1) determines whether the estimated time to bring the at least one CD online is above a predetermined threshold. In one or more embodiments, the predetermined threshold may depend on the CD group's (e.g., 106 in FIG. 1) ability to operate without the at least one CD. In one or more embodiments, the predetermined threshold may depend on the importance of CPs of CP group (e.g., 104 in FIG. 1) operating on the at least one CD that is offline. In one or more embodiments, the predetermined threshold may be determined by any means known in the art or discovered in the future. Accordingly, if the result is YES, then the method proceeds to step 404. If the result is NO, then the method ends.

As a result of the determination that the estimated time needed to bring the at least one CD online is above the predetermined threshold in step 402, in step 404, the CPE (e.g., 108 in FIG. 1) begins re-distributing the CPs of the CP group (e.g., 104 in FIG. 1) from the at least one CD is offline to the other CDs of the CD group (e.g., 106 in FIG. 1). In one or more embodiments, the CPE (e.g., 108 in FIG. 1) may redistribute the CPs by any means known in the art or discovered in the future. In one or more embodiments, following step 404, the method proceeds to step 202 in FIG. 2, where the CPE (e.g., 108 in FIG. 1) determines a CD group cost (i.e., the total cost of all the CPs running on each CD of the CD group (e.g., 106 in FIG. 1)) for each configuration of adding the CPs from the offline CD to the online CDs of the CD group (e.g., 106 in FIG. 1).

Embodiments of the disclosure may be implemented using computing devices. Turning to FIG. 5, FIG. 5 shows a diagram of a computing device (500) in accordance with one or more embodiments. The computing device (500) may include one or more computer processor(s) (502), non-persistent storage (504) (e.g., volatile memory, such as random access memory (RAM), cache memory), persistent storage (506) (e.g., a hard disk, an optical drive such as a compact disk (CD) drive or digital versatile disk (DVD) drive, a flash memory, etc.), a communication interface (508) (e.g., Bluetooth interface, infrared interface, network interface, optical interface, etc.), input devices (510), output devices (612), and numerous other elements (not shown) and functionalities. Each of these components is described below.

In one embodiment, the computer processor(s) (502) may be an integrated circuit for processing instructions. For example, the computer processor(s) (502) may be one or more cores or micro-cores of a processor. The computing device (500) may also include one or more input devices (510), such as a touchscreen, access keyboard, mouse, microphone, touchpad, electronic pen, or any other type of input device. The communication interface (508) may include an integrated circuit for connecting the computing device (500) to a network (not shown) (e.g., a local area network (LAN), a wide area network (WAN) such as the Internet, mobile network, or any other type of network) and/or to another device, such as another computing device.

In one embodiment, the computing device (500) may include one or more output devices (512), such as a screen (e.g., a liquid crystal display (LCD), a plasma display, touchscreen, cathode ray tube (CRT) monitor, projector, or other display device), a printer, external storage, or any other output device. One or more of the output devices (512) may be the same or different from the input devices (510). The input and output device(s) (510, 512) may be locally or remotely connected to the computer processor(s) (502), non-persistent storage (504), and persistent storage (506). Many diverse types of computing devices exist, and the aforementioned input and output device(s) (510, 512) may take other forms.

The problems discussed above should be understood as being examples of problems solved by embodiments of the disclosure and the disclosure should not be limited to solving the same/similar problems. The disclosed disclosure is broadly applicable to address a range of problems beyond those discussed herein.

In the detailed description of the embodiments of the disclosure above, numerous specific details are set forth in order to provide a more thorough understanding of one or more embodiments of the disclosure. However, it will be apparent to one of ordinary skill in the art that the one or more embodiments of the disclosure may be practiced without these specific details. In other instances, well-known features have not been described in detail to avoid unnecessarily complicating the description.

In the prior description of the figures, any component described with regard to a figure, in various embodiments of the disclosure, may be equivalent to one or more like-named components described with regard to any other figure. For brevity, descriptions of these components are not repeated with regard to each figure. Thus, each and every embodiment of the components of each figure is incorporated by reference and assumed to be optionally present within every other figure having one or more like-named components. Additionally, in accordance with various embodiments of the disclosure, any description of the components of a figure is to be interpreted as an optional embodiment, which may be implemented in addition to, in conjunction with, or in place of the embodiments described with regard to a corresponding like-named component in any other figure.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Further, throughout this application, elements of figures may be labeled as A to N. As used herein, the aforementioned labeling means that the element may include any number of items and does not require that the element include the same number of elements as any other item labeled as A to N unless otherwise specified. For example, a data structure may include a first element labeled as A and a second element labeled as N. This labeling convention means that the data structure may include any number of the elements. A second data structure, also labeled as A to N, may also include any number of elements. The number of elements of the first data structure and the number of elements of the second data structure may be the same or different.

As used herein, the phrase operatively connected, or operative connection, means that there exists between elements/components/devices a direct or indirect connection that allows the elements to interact with one another in some way. For example, the phrase ‘operatively connected’ may refer to any direct (e.g., wired directly between two devices or components) or indirect (e.g., wired and/or wireless connections between any number of devices or components connecting the operatively connected devices) connection. Thus, any path through which information may travel may be considered an operative connection.

Software instructions in the form of computer readable program code to perform embodiments described herein may be stored, in whole or in part, temporarily or permanently, on a non-transitory computer readable medium such as a CD, DVD, storage device, a diskette, a tape, flash memory, physical memory, or any other physical computer readable storage medium. Specifically, the software instructions may correspond to computer readable program code that, when executed by a processor(s), is configured to perform one or more embodiments described herein.

While embodiments described herein have been described with respect to a limited number of embodiments, those skilled in the art, having the benefit of this Detailed Description, will appreciate that other embodiments can be devised which do not depart from the scope of embodiments as disclosed herein. Accordingly, the scope of embodiments described herein should be limited only by the attached claims below.

What is claimed is:

1. A method for provisioning component applications (CPs) among a group of computing devices (CDs), the method comprising:
receiving a request to add a first CP of the CPs to one CD of the group of CDs;
determining a group of CP costs, wherein each cost of the group of CP costs corresponds to adding the first CP to an associated CD of the group of CDs, wherein each cost of the group of CP costs is based on a first type of the first CP, a second type of CP currently running on the associated CD, and a number of CPs currently running on the associated CD; and
placing the first CP on a first CD of the group of CDs associated with a lowest cost of the group of CP costs, wherein placing the first CP causes the first CP to begin running on the first CD.

2. The method of claim 1, wherein each CD of the group of CDs comprises a threshold capacity.

3. The method of claim 2, wherein if adding the first CP to a CD of the group of CDs exceeds the threshold capacity, then an associated cost is infinitely large.

4. The method of claim 2, wherein each cost of the group of CP costs is based on the threshold capacity.

5. The method of claim 4, wherein each cost of the group of CP costs is inversely proportional to the threshold capacity.

6. The method of claim 1, wherein the number of CPs currently running on the associated CD comprising a value of one or more causes a higher cost than the number having a value of zero.

7. The method of claim 1, wherein the first type matching the second type causes a higher cost than the first type not matching the second type.

8. The method of claim 1, wherein each costs is also based on an affinity between the first type and the second type.

9. The method of claim 1, further comprising:
determining that an update to the group of CDs or to the first CP has occurred;
determining, in response to the update, a second group of CP costs, wherein each cost of the second group of CP costs corresponds to adding the first CP to an associated CD of the group of CDs;
determining a set of differences between the lowest cost and each cost of the second group of CP costs;
making a first determination that at least one difference of the set of differences is above a predetermined threshold; and
redistributing, based on the first determination, the first CP from the first CD to a second CD associated with a lowest cost of the second group of CP costs.

10. The method of claim 1, further comprising:
receiving a notification that the first CD is offline;
making a second determination, in response to the notification, that an estimated time to bring the first CD online is above a predetermined threshold;
determining, in response to the second determination, a second group of CP costs, wherein each cost of the second group of CP costs corresponds to adding the first CP to an associated CD of the group of CDs; and
redistributing, based on the determining, CPs from the first CD that to a second CD associated with a lowest cost of the second group of CP costs.

11. A non-transitory computer readable medium (CRM) comprising computer readable program code, which when executed by a computer processor, enables the computer to perform a method for provisioning component applications (CPs) among a group of computing devices (CDs), the method comprising:
receiving a request to add a first CP of the CPs to one CD of the group of CDs;
determining a group of CP costs, wherein each cost of the group of CP costs corresponds to adding the first CP to an associated CD of the group of CDs, wherein each cost of the group of CP costs is based on a first type of the first CP, a second type of CP currently running on the associated CD, and a number of CPs currently running on the associated CD; and
placing the first CP on a first CD of the group of CDs associated with a lowest cost of the group of CP costs, wherein placing the first CP causes the first CP to begin running on the first CD.

12. The non-transitory CRM of claim 11, wherein each CD of the group of CDs comprises a threshold capacity.

13. The non-transitory CRM of claim 12, wherein if adding the first CP to a CD of the group of CDs exceeds the threshold capacity, then an associated cost is infinitely large.

14. The non-transitory CRM of claim 12, wherein each cost of the group of CP costs is based on the threshold capacity.

15. The non-transitory CRM of claim 11, wherein the first type matching the second type causes a higher cost than the first type not matching the second type.

16. The non-transitory CRM of claim 11, wherein each costs is also based on an affinity between the first type and the second type.

17. A system for provisioning component applications (CPs) among a group of computing devices (CDs), the system comprising:
persistent storage; and
a computing device, comprising a processor and memory, programmed to:
receive a request to add a first CP of the CPs to one CD of the group of CDs;
determine a group of CP costs, wherein each cost of the group of CP costs corresponds to adding the first CP to an associated CD of the group of CDs, wherein each cost of the group of CP costs is based on a first type of the first CP, a second type of CP currently running on the associated CD, and a number of CPs currently running on the associated CD; and
place the first CP on a first CD of the group of CDs associated with a lowest cost of the group of CP costs, wherein placing the first CP causes the first CP to begin running on the first CD.

18. The system of claim 17, wherein each CD of the group of CDs comprises a threshold capacity.

19. The system of claim 18, wherein if adding the first CP to a CD of the group of CDs exceeds the threshold capacity, then an associated cost is infinitely large.

20. The system of claim 18, wherein each cost of the group of CP costs is based on the threshold capacity.
